(19) United States
(12) Patent Application Publication
(10) Pub. No.: US 2006/0075495 A1
(43) Pub. Date: Apr. 6, 2006

(54) Information distribution apparatus and method and information reception method

(75) Inventor: Yoshiyuki Hayashi, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/240,526

(22) Filed: Oct. 3, 2005

(30) Foreign Application Priority Data
Oct. 4, 2004 (JP) 2004-291640

(51) Int. Cl. G06F 12/14

(52) U.S. Cl. 726/22

(57) ABSTRACT

An information distribution apparatus for conducting cryptographic communications, including a monitor circuit for monitoring the status of an encryption/decryption device. The monitor circuit continuously monitors the use rate of the encryption/decryption device, and when receiving a contents request from one or more of a plurality of reception apparatuses, accepts the contents request(s) as long as the use rate of the encryption/decryption is less than a system-defined reference use rate. This allows the encryption/decryption device to distribute contents to reception apparatuses of the number appropriate to the processing power thereof.

### CROSS-REFERENCE TO RELATED APPLICATIONS

This application claims priority under 35 U.S.C. §119 on Patent Application No. 2004-291640 filed in Japan on Oct. 4, 2004, the entire contents of which are hereby incorporated by reference.

### BACKGROUND OF THE INVENTION

The present invention relates to an information distribution apparatus, an information distribution method and an information reception method used in transmission/reception of data via a network such as the Internet, in which an encryption/decryption device can be effectively used when the data is encrypted in consideration of copyright protection before being transmitted/received.

As a conventional method for transmitting/receiving encrypted data, a transmission/reception method illustrated in FIG. 10 is known. In FIG. 10, an information distribution apparatus 1 and three reception apparatuses 3 to 5 are connected to a network 2. The distribution apparatus 1 includes a storage device 6 for storing contents, two encryption/decryption devices 7 and 8 and one communications device 9. When receiving a contents request from any of the reception apparatuses 3 to 5, the distribution apparatus 1 distributes contents encrypted with the encryption/decryption device 7 or 8 via its communications device 9 (see Japanese Laid-Open Patent Publication No. 2000-287192, for example).

However, the conventional distribution apparatus has the following problems. In the communications environment in which the distribution apparatus 1 and the plurality of reception apparatuses 3 to 5 are connected to the network 2, as shown in FIG. 10, the number of reception apparatuses with which the distribution apparatus 1 can conduct cryptographic communications simultaneously is limited to the number of encryption/decryption devices included in the distribution apparatus 1. For example, when the distribution apparatus 1, having two encryption/decryption devices 7 and 8 as shown in FIG. 10, is transmitting contents to two reception apparatuses 3 and 4, the distribution apparatus 1 fails to communicate with the third reception apparatus 5.

Furthermore, the number of reception apparatuses with which the distribution apparatus 1 can conduct cryptographic communications simultaneously is limited to an allowable range having as its maximum a value defined by an application of the distribution apparatus 1.

### SUMMARY OF THE INVENTION

An object of the present invention is providing an information distribution apparatus and method permitting distribution of contents to more reception apparatuses.

To attain the above object, the inventors of the present invention have made examinations and found the following. For example, in FIG. 10, when the encryption/decryption devices 7 and 8 are respectively conducting cryptographic communications with the reception apparatuses 3 and 4, the encryption/decryption devices 7 and 8 are in their active states but still have enough processing power to spare. It also has been found that even when the distribution apparatus 1 is transmitting contents to the maximum number of reception apparatuses equal to the number defined by an application of the distribution apparatus 1, the encryption/decryption devices 7 and 8 will still have enough processing power to spare if the bit rates of the contents for which cryptographic communications is made are low.

In view of the above, according to the present invention, the status such as the processing power of the encryption/decryption device that is presently distributing contents is monitored, so that the encryption/decryption device can be efficiently used.

The information distribution apparatus of the present invention is an information distribution apparatus for encrypting contents information and distributing the encrypted contents information to a plurality of reception apparatuses via a network conforming to a predetermined transport protocol, the apparatus including: an encryption/decryption device for encrypting the contents information; and a monitor circuit for monitoring the status of the encryption/decryption device.

In one embodiment of the information distribution apparatus described above, the monitor circuit includes: a use rate computation circuit for measuring a use time and an encrypted data amount per unit time for the encryption/decryption device and computing a use rate of the encryption/decryption device based on the unit time and the use time; and an encryption rate computation circuit for computing an encryption rate of the encryption/decryption device based on the unit time and the encrypted data amount.

The information distribution method of the present invention is an information distribution method for encrypting contents information using an encryption/decryption device and distributing the encrypted contents information to a plurality of reception apparatuses via a network conforming to a predetermined transport protocol, the method including the steps of: computing a use rate of the encryption/decryption device when, in the midst of distribution of contents information to any of the plurality of reception apparatuses, receiving a contents request from another one of the reception apparatuses (computing step); and rejecting the contents request if the use rate of the encryption/decryption device exceeds a predetermined reference value (rejecting step).

Alternatively, the information distribution method of the present invention is an information distribution method for encrypting contents information using an encryption/decryption device and distributing the encrypted contents information to a plurality of reception apparatuses via a network conforming to a predetermined transport protocol, the method including the steps of: computing a use rate and an encryption rate of the encryption/decryption device when, in the midst of distribution of contents information to any of the plurality of reception apparatuses, receiving a contents request from another one of the reception apparatuses (use rate computing step); detecting a compression rate of contents information requested under the contents request (detecting step); computing an estimated use rate of the encryption/decryption device presumed to be obtained if the contents request is accepted, based on the use rate, the encryption rate and the compression rate (estimated use rate computing step); and rejecting the contents request if the estimated use rate exceeds a predetermined reference value (rejecting step).

In one embodiment of the information distribution apparatus described above, the apparatus further includes a change circuit for changing the priority of contents information presently being distributed based on an encryption mode of the contents information presently being distributed, wherein the change circuit changes the priority of contents information presently being distributed based on the encryption mode of the contents information presently being distributed if the information distribution apparatus receives a contents request from any of the plurality of reception apparatuses, and the monitor circuit determines acceptance or rejection of the contents request according to the priority changed by the change circuit.

In one embodiment of the information distribution method described above, the method further includes the steps of: changing at least one of the priority of the contents information presently being distributed and the priority of contents information requested under the contents request from any of the plurality of reception apparatuses, based on an encryption mode of the contents information presently being distributed, if the contents request is rejected in the rejecting step (changing step); and distributing the contents information presently being distributed and the contents information requested under the contents request based on the changed priority (distributing step).

In another embodiment of the information distribution method described above, the method further includes the steps of: searching any other information distribution style than that currently designated with which the estimated use rate computed in the estimated use rate computing step be less than a predetermined reference value if the contents request from any of the plurality of reception is rejected in the rejecting step (searching step); notifying the reception apparatus that transmitted the contents request of all of a plurality of other information distribution styles if the plurality of other information distribution styles were retrieved in the searching step (notifying step); and distributing information based on a selected information distribution style if the reception apparatus that transmitted the contents request selects one from the plurality of other information distribution styles (distributing step). In yet another embodiment of the information distribution method described above, the plurality of other information distribution styles are special playback styles including I-frame playback, skip playback and slow playback.

The information reception method of the present invention is an information reception method for receiving distribution of contents information from an information distribution apparatus via a network conforming to a predetermined transport protocol, the method including the steps of: transmitting a contents request to the information distribution apparatus (requesting step); selecting one from a plurality of other information distribution styles than that designated in the contents request if being notified of the plurality of other information distribution styles by the information distribution apparatus (selecting step); and notifying the information distribution apparatus of the information distribution style selected in the selecting step (notifying step).

As described above, according to the present invention, the status of the encryption/decryption device is monitored, and contents are respectively distributed to a plurality of reception apparatuses as long as the use rate, for example, of the encryption/decryption device is less than the reference value or as long as the estimated use rate presumed when including the reception apparatus to which contents are presently being distributed and a reception apparatus that has newly transmitted a contents request is less than the limit use rate.

Thus, information distribution making the most of the processing power of the encryption/decryption device, without being limited by the number of reception apparatuses that receive information simultaneously, is attained. For example, simultaneous reception of information by more reception apparatuses is possible in the case that the bit rates of encryption of a plurality of items of contents are all low, for example.

### BRIEF DESCRIPTION OF THE DRAWINGS

FIG. 1 is a view showing a configuration of a network including an information distribution apparatus of Embodiment 1 of the present invention.

FIG. 2 is a view showing an information distribution method using the information distribution apparatus of Embodiment 1.

FIG. 3 is a view showing an information distribution method using an information distribution apparatus of Embodiment 2 of the present invention.

FIG. 4 is a view showing a configuration of a network including an information distribution apparatus of Embodiment 3 of the present invention.

FIG. 5 is a view showing an example of correspondence between the encryption mode and the priority in the information distribution apparatus of Embodiment 3.

FIG. 6 is a view showing an information distribution method using the information distribution apparatus of Embodiment 3.

FIG. 7 is a view showing another information distribution method using the information distribution apparatus of Embodiment 3.

FIG. 8 is a view showing an example of relationship between the distribution method and the bit rate of encryption in an information distribution apparatus of Embodiment 4 of the present invention.

FIG. 9 is a view showing an information distribution method using the information distribution apparatus of Embodiment 4.

FIG. 10 is a view showing a configuration of a network including a conventional information distribution apparatus.

### DESCRIPTION OF THE PREFERRED EMBODIMENTS

Hereinafter, preferred embodiments of the present invention will be described with reference to the accompanying drawings.

### Embodiment 1

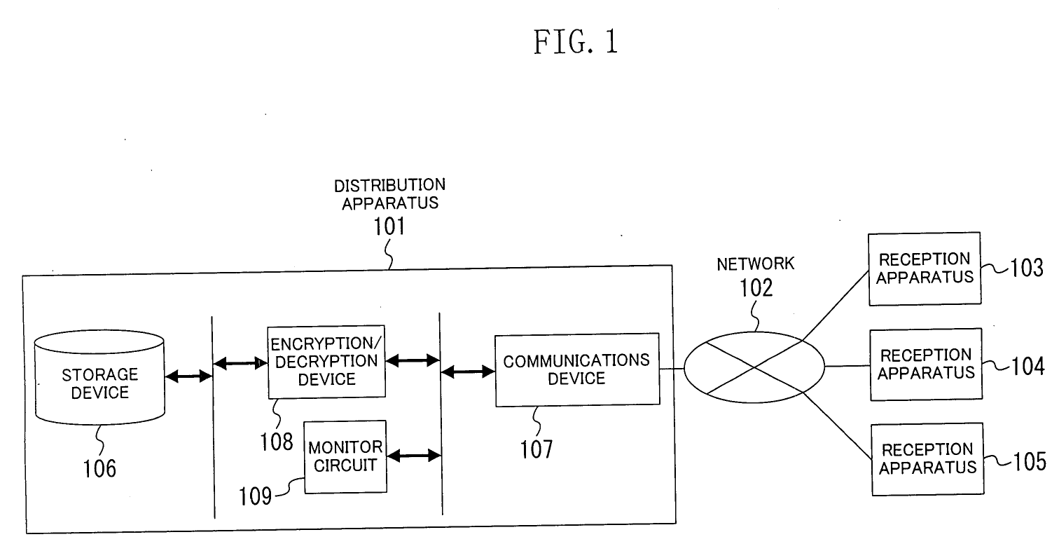

FIG. 1 shows a configuration of an information distribution system including an information distribution apparatus of Embodiment 1.

Referring to FIG. 1, a contents distribution apparatus (information distribution apparatus) 101 and three reception apparatuses 103 to 105 are connected to a network 102 conforming to a predetermined transport protocol. Naturally, the number of reception apparatuses is not limited to three, but the present invention is also applicable to situations having two, four and more reception apparatuses.

The distribution apparatus 101 includes a storage device 106, one encryption/decryption device 108 and one communications device 107. The number of encryption/decryption devices and the number of communications devices are not limited to one as shown in FIG. 1 but can be arbitrarily determined. A plurality of items of contents are stored in advance in the storage device 106.

The distribution apparatus 101 also includes a monitor circuit 109. The monitor circuit 109 continuously monitors the status of the encryption/decryption device 108 to measure the use time and the encrypted data amount per unit time for the encryption/decryption device 108. Communications of the distribution apparatus 101 with the reception apparatuses 103 to 105 is made via the communications device 107. The monitor circuit 109 computes a use rate P of the encryption/decryption device 108 by the expression “use rate P =use time/unit time×100”. A reference use rate Pt is preset in the monitor circuit 109 to be used as the reference for determination on whether a contents request from any of the reception apparatuses 103 to 105 should be accepted or rejected.

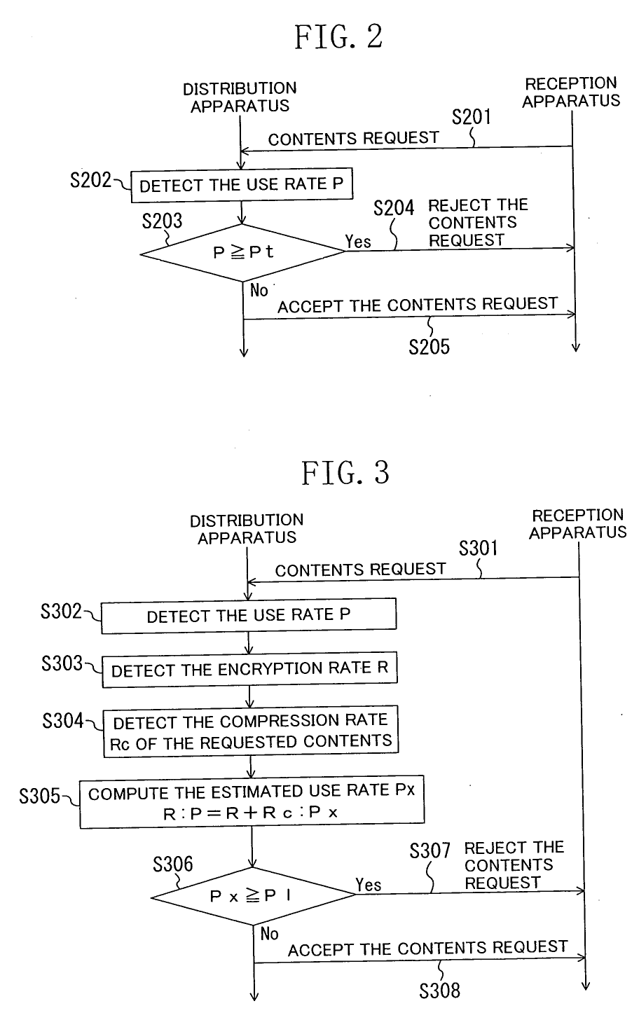

Hereinafter, a method of determining whether to accept or reject a contents request when the distribution apparatus 101 newly receives the contents request from the reception apparatus 104 while conducting cryptographic communications with the reception apparatus 103 will be described with reference to FIG. 2.

The reception apparatus 104 transmits a contents request to the distribution apparatus 101 (step S201). Receiving the contents request, the distribution apparatus 101 detects the current use rate P by computation in the monitor circuit 109 (computing step S202 and use rate computation circuit), and compares the use rate P with the preset reference use rate Pt (step S203). If the use rate P is less than the reference use rate Pt, the distribution apparatus 101 notifies the reception apparatus 104 of acceptance of the contents request (step S205). If the use rate P is equal to or more than the reference use rate Pt, the distribution apparatus 101 notifies the reception apparatus 104 of rejection of the contents request (step S204).

When the distribution apparatus 101 includes a plurality of encryption/decryption devices, the distribution apparatus 101 sequentially compares the use rates P of all the encryption/decryption devices with the reference use rates Pt set for the respective devices, and determines whether to accept or reject the contents request from the comparison results for all the encryption/decryption devices.

### Embodiment 2

In Embodiment 1, a new contents request is accepted and the relevant contents are distributed if the current use rate P is less than the reference use rate Pt. As a result of the acceptance of the new contents request, the use rate P may then exceed 100%. In this case, encryption of the contents may not be in time causing intermittence of the contents during distribution. Embodiment 2 proposes a method in which the use rate P is prevented from exceeding a limit use rate Pl as the reference value of the use limit of the system.

The method of this embodiment will be described with reference to FIGS. 1 and 3. Note that the limit use rate Pl satisfies “reference use rate Pt≦limit use rate Pl≦100[%]”.

Consider the case that the distribution apparatus 101 newly receives a contents request from the reception apparatus 104 while conducting cryptographic communications with the reception apparatus 103.

Referring to FIG. 3, the reception apparatus 104 transmits a contents request to the distribution apparatus 101 (step S301). Receiving the contents request, the distribution apparatus 101 detects the current use rate P by computation (computing step S302 and use rate computation circuit), detects an encryption rate R by computation (step S303) and further detects a compression rate Rc (for example, the bit rate) of the contents requested by the reception apparatus 104 (detecting step S304), in the monitor circuit 109, to thereby computes an estimated use rate Px presumed to be obtained if the contents request is accepted (estimated use rate computing step S305). The encryption rate R is computed by the expression “encryption rate R=encrypted data amount/unit time”. The compression rate Rc of the requested contents is obtained from information contained in the contents themselves or by being externally designated. The estimated use rate Px is computed by the expression “estimated use rate Px=use rate P×(1+compression rate Rc of the requested contents/encryption rate R).

The computed estimated use rate Px is then compared with the limit use rate Pl (step S306). If the estimated use rate Px exceeds the limit use rate Pl, the distribution apparatus 101 notifies the reception apparatus 104 of rejection of the contents request (rejecting step S307). If the estimated use rate Px does not exceed the limit use rate Pl, the distribution apparatus 101 notifies the reception apparatus 104 of acceptance of the contents request (step S308).

When the distribution apparatus 101 includes a plurality of encryption/decryption devices, the distribution apparatus 101 computes the estimated use rate Px for all the encryption/decryption devices, and compares the computed estimated use rates Px with the respective limit use rates Pl sequentially to determine whether to accept or reject the contents request.

### Embodiment 3

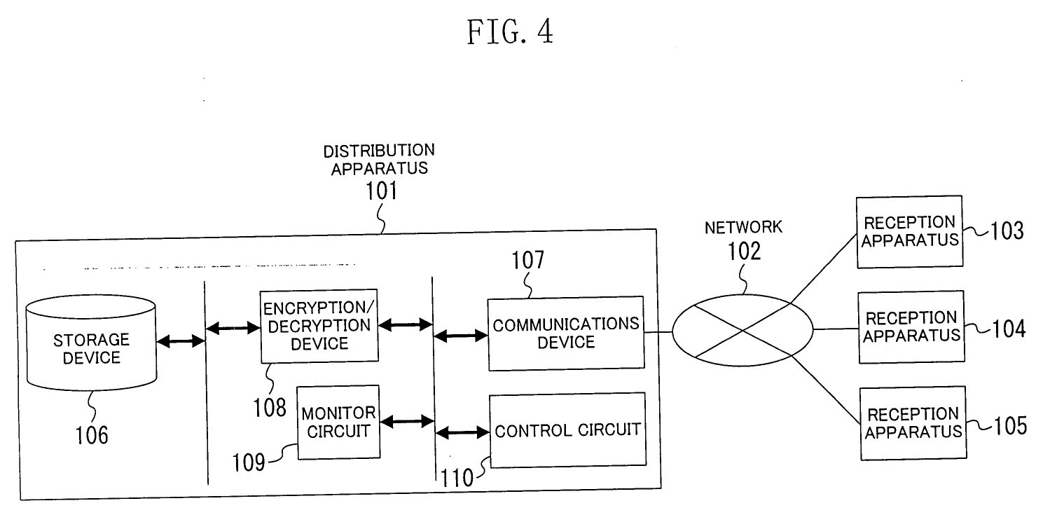

FIG. 4 shows a configuration of an information distribution system including an information distribution apparatus of Embodiment 3. The information distribution apparatus of this embodiment includes a control circuit 110 in addition to the components of the information distribution apparatus of Embodiment 1.

When a contents request from any of the reception apparatus 103 to 105 is rejected by the monitor circuit 109, the control circuit 110 can control the priority of distribution of the contents presently being distributed based on the encryption mode of the contents presently being distributed (when the priority is high, the use rate P and the encryption rate R become high). Simultaneously, the control circuit 110 can control the priority of distribution of the contents requested based on the encryption mode of the contents requested.

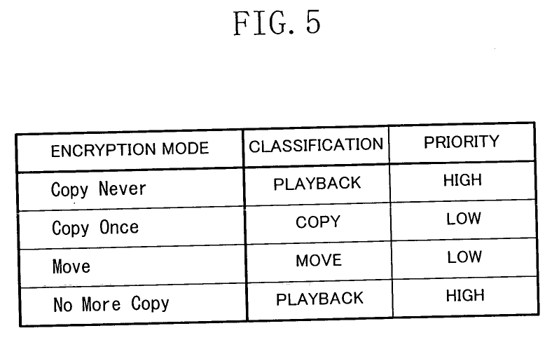

For example, as shown in FIG. 5, encryption modes of Copy Never, Copy Once, Move and No More Copy are provided in consideration of copyright protection, in which Copy Never and No More Copy are classified as “Playback” and high in priority, Copy Once is classified as “Copy” and low in priority, and Move is classified as “Move” and low in priority.

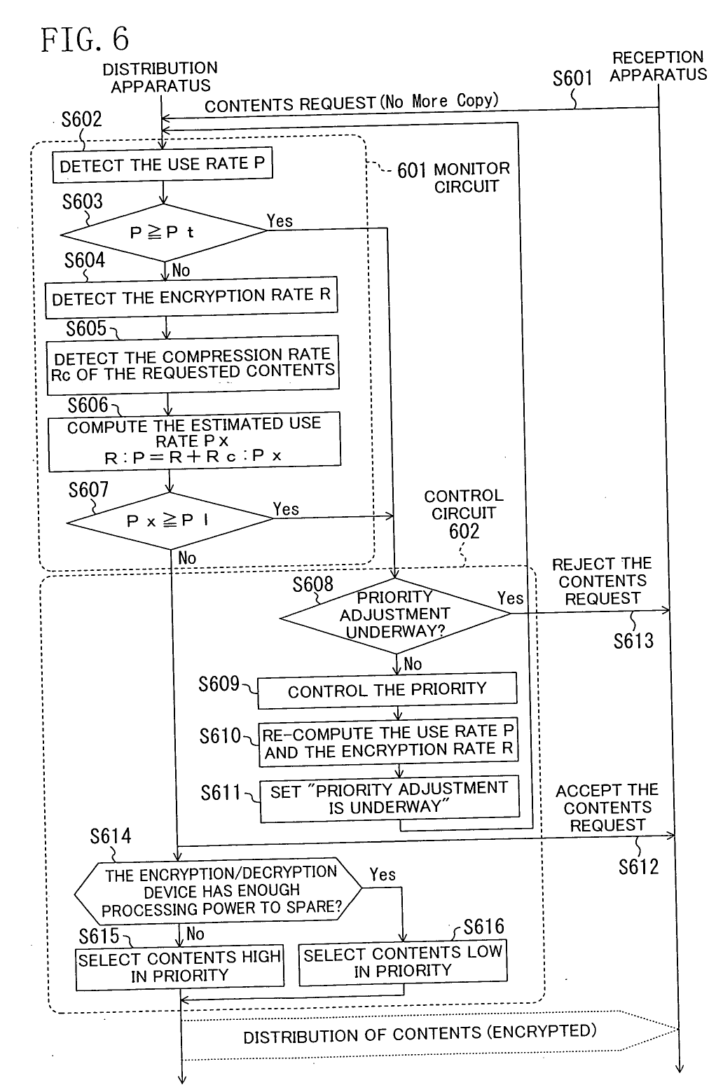

Consider, for example, the case that the distribution apparatus 101 receives a contents request in the No More Copy mode from the reception apparatus 105 while conducting cryptographic communications with the reception apparatus 103 in the Copy Never mode and with the reception apparatus 104 in the Move mode, and at this time, the use rate P is equal to or more than the reference use rate Pt(P≧Pt), or the estimated use rate Px presumed to be obtained if the contents request from the reception apparatus 105 is accepted is equal to or more than the limit use rate Pl(Px≧Pl). This case will be described with reference to FIG. 6.

If the contents request from the reception apparatus 105 (step S601) is rejected by a monitor circuit 601, a control circuit 602 first determines whether or not priority adjustment is underway (step S608). Since priority adjustment is not underway initially, the priority of the contents presently being distributed is controlled based on the encryption mode (changing step S609 and change circuit). In this example, the priority of the contents presently being distributed in the Move mode is lowered. The use rate P and the encryption rate R are computed again (step S610), and “priority adjustment is underway” is stored (step S611).

Thereafter, the monitor circuit 601 again determines whether to accept or reject the contents request. If the contents request is rejected again, it is determined that the priority adjustment is underway in the step S608 this time. The distribution apparatus therefore notifies the reception apparatus 105 of rejection of the contents request (step S613). On the contrary, if the contents request has become acceptable by the control of the priority in the step S609, the distribution apparatus notifies the reception apparatus 105 of acceptance of the contents request and executes distribution of the contents (distributing step S612). At this time, whether or not the encryption/decryption device 108 has enough processing power to spare is determined (step S614). Contents high in priority are selected if there is no enough power (step S615), and selection is made from contents low in priority if there is enough power to spare (step S616), to execute distribution of contents. As used herein, the situation that the encryption/decryption device has enough processing power to spare refers to the case that the use rate P updated at any time satisfies “use rate P<reference use rate Pt”.

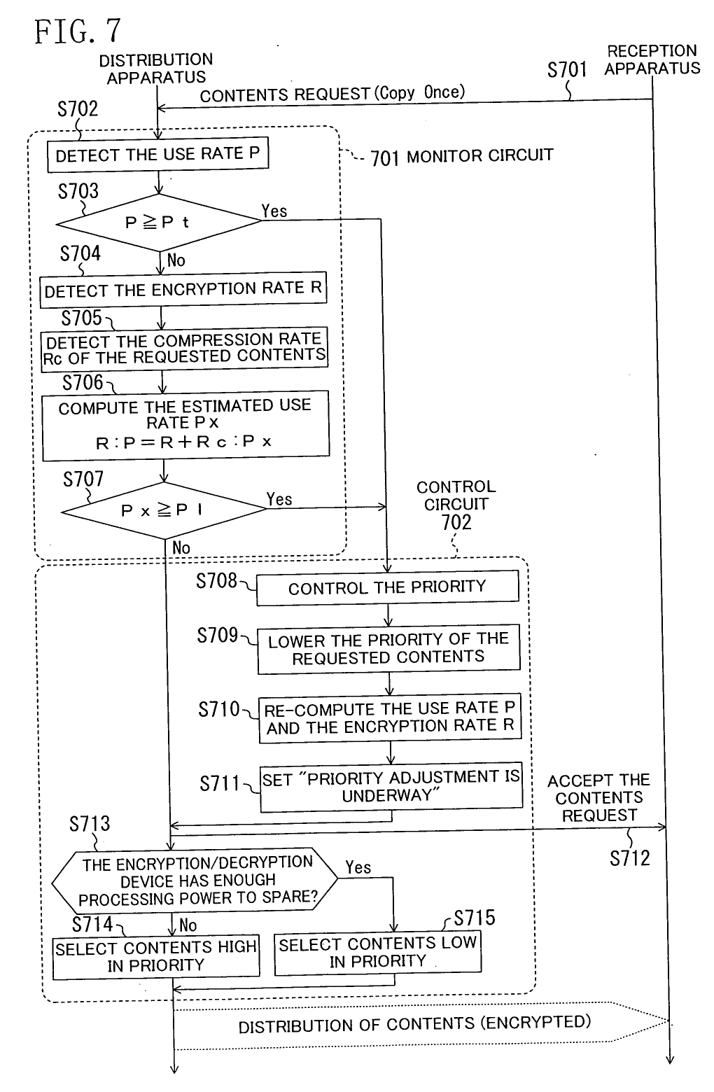

Next, the case of receiving a contents request from the reception apparatus 105 in the Copy Once mode under the same conditions as those described above will be described with reference to FIG. 7.

If the contents request from the reception apparatus 105 (step S701) is rejected by a monitor circuit 701, a control circuit 702 controls the priority of the contents presently being distributed based on the encryption mode (step S708). Also, since the encryption mode of the requested contents is Copy Once, the control circuit 702 lowers the priority of distribution of the requested contents (step S709). Thereafter, the use rate P and the encryption rate R are computed again (step S710), and “priority adjustment is underway” is stored (step S711). After termination of the above processing, the distribution apparatus notifies the reception apparatus 105 of acceptance of the contents request and executes distribution of the contents (step S712). At this time, whether or not the encryption/decryption device 108 has enough processing power to spare is determined (step S713). Contents high in priority are selected if there is no enough power (step S714), and selection is made from contents low in priority if there is enough power to spare (step S715)

In this embodiment, the encryption modes are classified to set the priorities at two levels as shown in FIG. 5. The encryption modes are not necessarily classified, but the priorities may be set for the encryption modes. In this case, also, the methods described above can be implemented.

If the protocol permits fixing of the priority or adding of information similar to the priority at the time of transmission of a contents request from a reception apparatus, precedence may be given to such information. The encryption mode is not necessarily designated at the time of transmission of a contents request. Instead, contents stored in the storage device 106 may be made adaptive to copyright protection or the like, and a circuit for determining the encryption mode at the time of distribution may be provided. The present invention is also applicable to this case.

### Embodiment 4

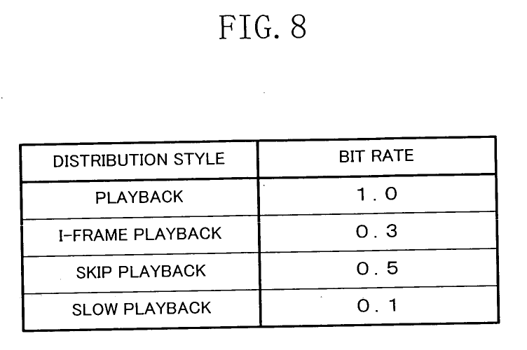

In Embodiment 4, described will be a distribution control method employed when the distribution apparatus is provided with special playback styles in addition to normal playback, such as “I-frame playback”, “skip playback” and “slow playback”, as distribution styles similar to “playback”, as shown in FIG. 8.

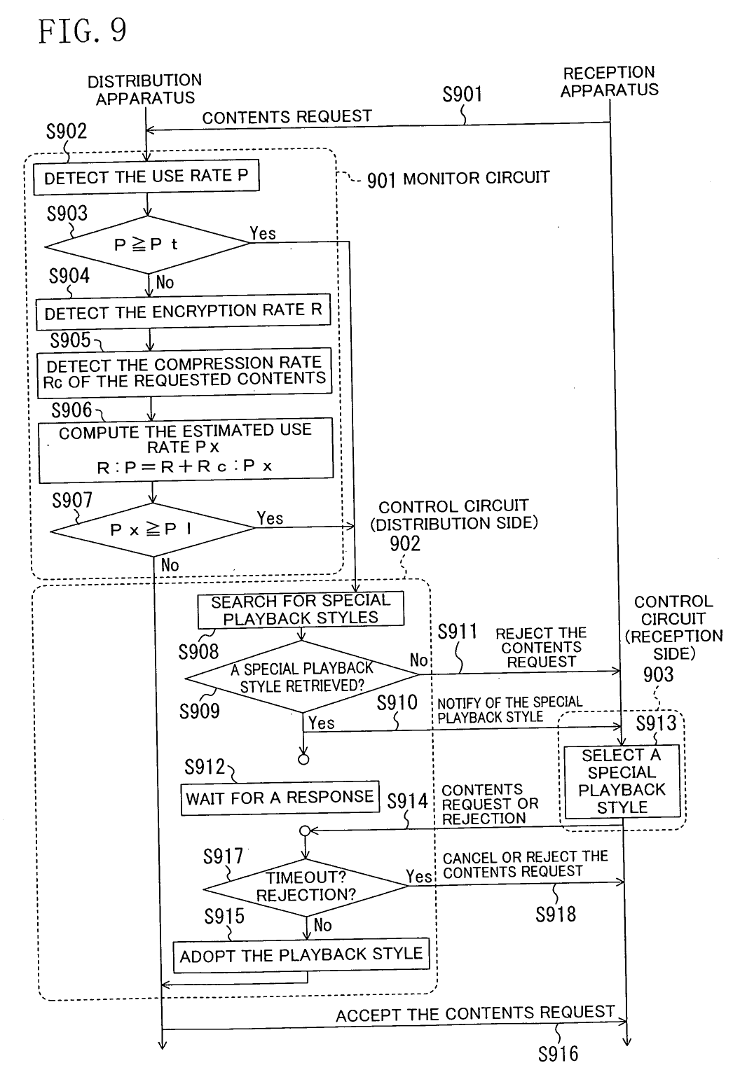

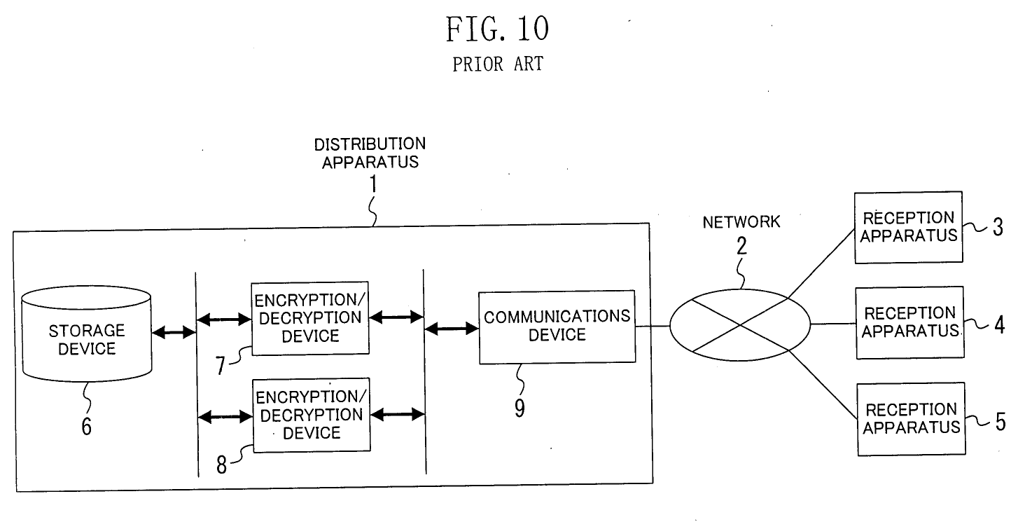

FIG. 9 shows an information distribution method of this embodiment in detail. The configuration of an information distribution apparatus of this embodiment is identical to that shown in FIG. 4, and thus detailed description thereof is omitted here.

Referring to FIG. 9, the distribution apparatus 101 receives a contents request from the reception apparatus (105, for example) (requesting step S901). If the request is rejected by a monitor circuit 901, a control circuit 902 computes the estimated use rate Px presumed to be obtained if each of the special playback styles shown in FIG. 8 is executed, sing the use rate P and the encryption rate R obtained in the monitor circuit 901, to hereby search for special playback styles with which the estimated use rate Px does not exceed the limit use rate Pl (searching step S908). For example, consider the bit rates shown in FIG. 8 (the bit rates in FIG. 8 are expressed as values with respect to the bit rate of the same contents in the distribution style “Playback” as 1.0). There may be a case that while the estimated use rate Px exceeds the limit use rate Pl when normal “Playback” and “Skip playback” are adopted, it is less than the limit use rate Pl when “I-frame playback” and “Slow playback” are adopted. In such a case, the two playback styles, “I-frame playback” and “Slow playback” are obtained as the result of search for executable special playback styles.

As described above, if determining that there are special playback styles (step S909), the distribution apparatus notifies the reception apparatus 105 of the executable special playback styles (notification step S910). The distribution apparatus 101 is then in a response waiting state only for the reception apparatus 105 (step S912) while continuing the processing for the other reception apparatuses 103 and 104 in parallel. The reception apparatus 105, receiving the notification that the two playback styles, “I-frame playback” and “Slow playback” are available, selects one of the notified special playback styles or selects to reject any of them (selecting step S913), and notifies the distribution apparatus 101 of the selection result (notifying step S914).

If any of the special playback styles are rejected by the reception apparatus 105 (step S914), the response waiting state of the distribution apparatus 101 (step S912) is canceled, and the reception apparatus 105 is notified of this cancellation (step S918). If having received a renewed contents request designating any special playback style from the reception apparatus 105, the distribution apparatus 101 adopts the designated special playback style (step S915), accepts the contents request from the reception apparatus 105, and distributes the contents according to the special playback style (distributing step S916). If no designation of a special playback style has been received from the reception apparatus 105 during a lapse of a predetermined time, a timeout occurs (step S917) canceling the response waiting time of the distribution apparatus 101 (step S912). After the timeout, any contents request designating a special playback style from the reception apparatus 105, if any, is rejected (step S918). In the step S909 for determining a special playback style, if there is no executable special playback style, the reception apparatus 105 is notified of rejection of the contents request (step S911).

The three special playback styles, “I-frame playback”, “skip playback” and “slow playback” were used for the description of this embodiment. The present invention can also be implemented for cases of using other special playback styles (“pause”, for example) and contents distribution styles that affect the use rate of the encryption/decryption device 108.

In the above description, the distribution apparatus includes one encryption/decryption device. Alternatively, a plurality of encryption/decryption devices may be provided. In this case, the monitor circuit 109 may measure the use rate R and the encryption rate R for each of the encryption/decryption devices.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. An information distribution apparatus for encrypting contents information and distributing the encrypted contents information to a plurality of reception apparatuses via a network conforming to a predetermined transport protocol, the apparatus comprising:
an encryption/decryption device for encrypting the contents information; and
a monitor circuit for monitoring the status of the encryption/decryption device.

2. The apparatus of claim 1, wherein the monitor circuit comprises:
a use rate computation circuit for measuring a use time and an encrypted data amount per unit time for the encryption/decryption device and computing a use rate of the encryption/decryption device based on the unit time and the use time; and
an encryption rate computation circuit for computing an encryption rate of the encryption/decryption device based on the unit time and the encrypted data amount.

3. An information distribution method for encrypting contents information using an encryption/decryption device and distributing the encrypted contents information to a plurality of reception apparatuses via a network conforming to a predetermined transport protocol, the method comprising the steps of:
computing a use rate of the encryption/decryption device when, in the midst of distribution of contents information to any of the plurality of reception apparatuses, receiving a contents request from another one of the reception apparatuses (computing step); and
rejecting the contents request if the use rate of the encryption/decryption device exceeds a predetermined reference value (rejecting step).

4. An information distribution method for encrypting contents information using an encryption/decryption device and distributing the encrypted contents information to a plurality of reception apparatuses via a network conforming to a predetermined transport protocol, the method comprising the steps of:
computing a use rate and an encryption rate of the encryption/decryption device when, in the midst of distribution of contents information to any of the plurality of reception apparatuses, receiving a contents request from another one of the reception apparatuses (use rate computing step);
detecting a compression rate of contents information requested under the contents request (detecting step);
computing an estimated use rate of the encryption/decryption device presumed to be obtained if the contents request is accepted, based on the use rate, the encryption rate and the compression rate (estimated use rate computing step); and
rejecting the contents request if the estimated use rate exceeds a predetermined reference value (rejecting step).

5. The apparatus of claim 1, further comprising a change circuit for changing the priority of contents information presently being distributed based on an encryption mode of the contents information presently being distributed,
wherein the change circuit changes the priority of contents information presently being distributed based on the encryption mode of the contents information presently being distributed if the information distribution apparatus receives a contents request from any of the plurality of reception apparatuses, and
the monitor circuit determines acceptance or rejection of the contents request according to the priority changed by the change circuit.

6. The method of claim 3, further comprising the steps of:
changing at least one of the priority of the contents information presently being distributed and the priority of contents information requested under the contents request from any of the plurality of reception apparatuses, based on an encryption mode of the contents information presently being distributed, if the contents request is rejected in the rejecting step (changing step); and
distributing the contents information presently being distributed and the contents information requested under the contents request based on the changed priority (distributing step).

7. The method of claim 4, further comprising the steps of:
changing at least one of the priority of the contents information presently being distributed and the priority of contents information requested under the contents request from any of the plurality of reception apparatuses, based on an encryption mode of the contents information presently being distributed, if the contents request is rejected in the rejecting step (changing step); and
distributing the contents information presently being distributed and the contents information requested under the contents request based on the changed priority (distributing step).

8. The method of claim 4, further comprising the steps of:
searching for other information distribution styles than that currently designated with which the estimated use rate computed in the estimated use rate computing step be less than a predetermined reference value if the contents request from any of the plurality of reception is rejected in the rejecting step (searching step);
notifying the reception apparatus that transmitted the contents request of all of a plurality of other information distribution styles if the plurality of other information distribution styles were retrieved in the searching step (notifying step); and
distributing information based on a selected information distribution style if the reception apparatus that transmitted the contents request selects one from the plurality of other information distribution styles (distributing step).

9. The method of claim 8, wherein the plurality of other information distribution styles are special playback styles including I-frame playback, skip playback and slow playback.

10. A information reception method for receiving distribution of contents information from an information distribution apparatus via a network conforming to a predetermined transport protocol, the method comprising the steps of:
transmitting a contents request to the information distribution apparatus (requesting step);
selecting one from a plurality of other information distribution styles than that designated in the contents request if being notified of the plurality of other information distribution styles by the information distribution apparatus (selecting step); and
notifying the information distribution apparatus of the information distribution style selected in the selecting step (notifying step).
